(19) United States
(12) Patent Application Publication
(10) Pub. No.: US 2016/0288394 A1
(43) Pub. Date: Oct. 6, 2016

(54) RESIN TRANSFER MOLDING WITH RAPID CYCLE TIME

(71) Applicant: CONTINENTAL STRUCTURAL PLASTICS, INC., Auburn Hills, MI (US)

(72) Inventors: Probir Kumar Guha, Troy, MI (US); Michael J. Siwajek, Auburn Hills, MI (US)

(21) Appl. No.: 15/035,163

(22) PCT Filed: Dec. 3, 2014
(86) PCT No.: PCT/US2014/068326

§ 371 Date: May 6, 2016

Related U.S. Application Data
(60) Provisional application No. 61/910,974, filed on Dec. 3, 2013.

(51) Int. Cl. B29C 45/78; B29C 45/00; B29C 70/48; B29C 45/02; B29C 45/77

(52) U.S. Cl. CPC B29C 45/78; B29C 45/02; B29C 45/77; B29C 70/48; B29C 45/0005; B29C 2945/76531; B29C 2945/76498; B29C 2945/76732; B29C 2945/76765; B29K 2105/08

(57) ABSTRACT

A process for resin transfer molding (RTM) with staggered injection of a resin is provided that injects resin into a plurality of injection ports of a mold. The temperature and pressure applied to the mold are controlled during injection to limit promote rapid filling of the mold cavity. The injection ports are activated for injecting the resin in any order of individually, in groups, or pairings. Fibers are readily added to the mold separately or within the resin. Cycle times of from 1 to 5 minutes are provided for the process.

### RELATED APPLICATIONS

This application claims priority benefit of U.S. Provisional Application Ser. No. 61/910,974 filed 3 Dec. 2013; the contents of which are hereby incorporated by reference.

### FIELD OF THE INVENTION

The present invention in general relates to resin transfer molding and in particular to an improved resin transfer molding process with a staggered injection of resin by time and position in a multipoint injection system.

### BACKGROUND OF THE INVENTION

Resin transfer molding (RTM) is a method of fabricating composite structures with high strength, complex geometries, tight dimensional tolerances, and part quality typically required for automotive and aerospace applications. RTM uses a closed mold commonly made of aluminum with a fiber “lay-up” such as graphite placed into the mold. The mold is closed, sealed, heated, and placed under vacuum. A room temperature (20° C.) or heated resin is then injected into the mold to impregnate the fiber layup. Having the mold heated and under vacuum assists the resin flow. The mold is then held at a temperature sufficient to cure the resin. Typically, a resin experiences three distinct states during the RTM process; a viscous state during injection, a jelling state during which the viscosity of the resin changes to a higher viscosity, and a cure time when the resin materials chemically crosslink and the resin hardens. Molds used for RTM have one or more injection ports for introducing the resin, and at least one exhaust port for gas and excess resin to leave the mold. Multiport injection molds are typically used for larger parts that have an increased processing time.

A common problem encountered during the RTM process is a non-uniform flow of the resin, where the resin experiences a change in viscosity as the resin travels away from the injection point. Furthermore, as shown in the graph of FIG. 1 as the time of processing progresses the pressure and temperature experienced by the resin decreases as a function of time. The aforementioned problems experienced during the RTM process contribute to defects in formed parts.

Thus, there exists a need for an improved RTM multiport injection process that minimizes both production defects and cycle time.

### SUMMARY OF THE INVENTION

A process for resin transfer molding (RTM) with staggered injection of a resin is provided that injects resin into a plurality of injection ports of a mold. The temperature and pressure applied to the mold are controlled during injection to limit promote rapid filling of the mold cavity. The injection ports are activated for injecting the resin in any order of individually, in groups, or pairings. Fibers are readily added to the mold separately or within the resin. Cycle times of from 1 to 5 minutes are provided for the process.

### BRIEF DESCRIPTION OF THE DRAWINGS

FIG. 1 is a graph showing the typical response curve as the time of processing progresses the pressure and temperature experienced by the resin decreases as a function of time; a

FIG. 2 is a graph showing the response curve of pressure and temperature as a function of time for resin with staggered injection in a multiport RTM mold according to an embodiment of the inventive process;

FIG. 3 is a plan view of a multiport RTM mold with four injection ports for staggered resin injection according to embodiments of the invention;

FIG. 4 is a plan view of a multiport RTM mold with six injection ports for staggered resin injection according to embodiments of the invention; and

FIG. 5 is a flowchart of a production process of the staggered multiport RTM process according to embodiments of the invention.

### DETAILED DESCRIPTION OF THE INVENTION

The present invention has utility as an improved resin transfer molding (RTM) process with a staggered injection of resin by time and position in a multipoint injection system. The staggered introduction of resin in a mold provides for an improved pressure and temperature profile versus time for the resin used for forming parts versus existing RTM processes that simultaneously inject resin. The staggered introduction of resin in embodiments of the inventive process provide for improved product yields with fewer formed part defects resulting from non-impregnated portions, thereby improving the quality of the molded product. Furthermore, product cycle time is also reduced by staggering the injection of resin in a multiport mold versus the existing process of simultaneous injection of resin in a multiport mold. It has been observed that cycle time for forming parts have been reduced from approximately 10-60 minutes to three to five minutes with the inventive process of staggering the injection of resin in a multiport mold.

Resins used in embodiments of the inventive staggered RTM process include thermosetting resins such as epoxy; urethanes; polyesters, and vinylesters; that are low in viscosity and easy to be impregnated into reinforcing fibers. These resins illustratively include epoxy resin, an unsaturated polyester resin, a polyvinylester resin, a phenolic resin, a guanamine resin, a polyimide resin such as bismaleimide triazine resin, a furan resin, a polyurethane resin, a polydiarylphthalate resin, a melamine resin, a urea resin, an amino resin, etc. Fibers may be introduced to the resin used in certain embodiments of the inventive staggered RTM process to strengthen formed parts including glass, carbon, and other synthetic fibers, as well as natural fibers. Natural fibers may include coconut fibers, bamboo fibers, sugar cane fibers, banana skin fibers, etc.

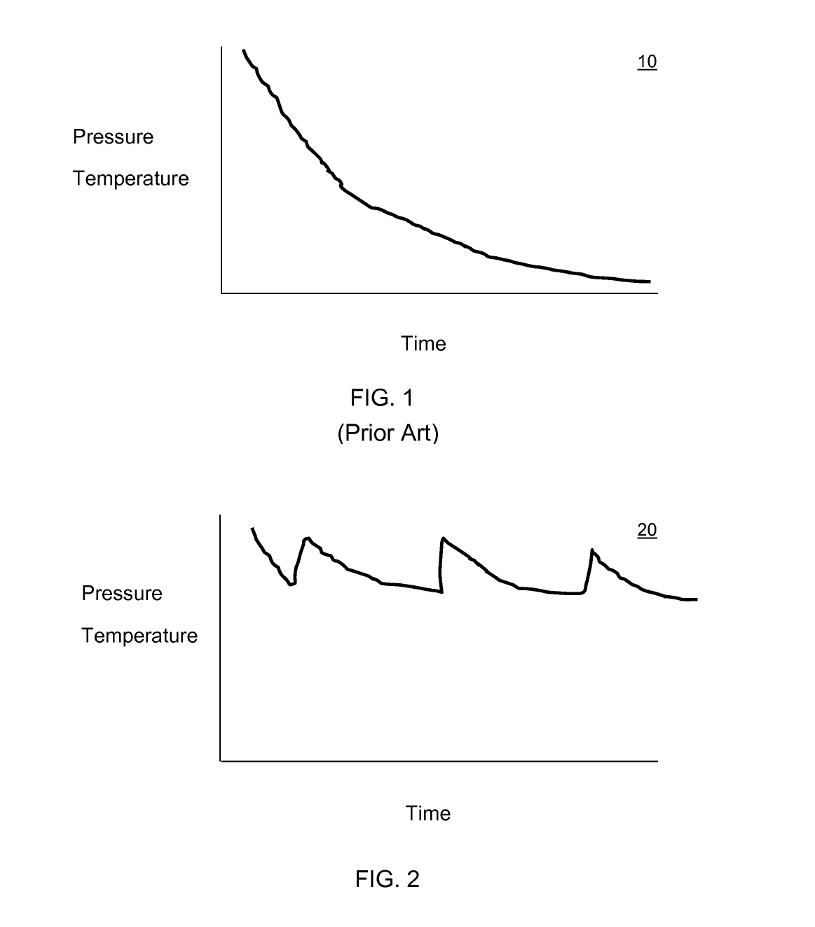

Referring now to FIG. 2, a graph 20 showing the response curve of pressure and temperature as a function of time for resin with staggered injection in a multiport RTM mold according to an embodiment of the inventive process. As can be seen as compared to the graph 10 of FIG. 1 for a simultaneous injected part, the rapid decline of pressure and temperature during the processing of a molded part in the mold is avoided compared to conventional RTM process, and the temperature and pressure is maintained during the RTM process of embodiments of the invention to increase cycle time of molding a part.

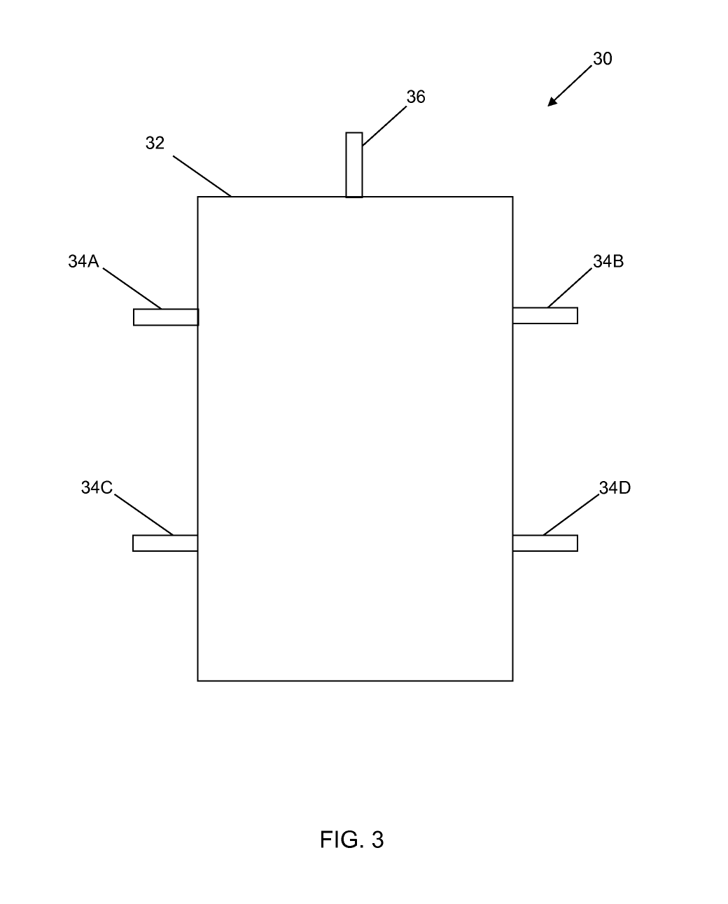

FIG. 3 is a plan view of a multiport RTM system 30 with a mold 32 with four injection ports 34A-34C for staggered resin injection and an exhaust port 36 according to embodiments of the invention. In embodiments of the staggered RTM process the injection ports may be activated in any order both individually, and in groups, or pairings. For example, injection ports 34A and 34B may be turned on as a pair and alternated with injection ports 34C and 34D as a second pair, where the adjacent pairings (34A-34B, 34C-34D) inject resin at alternating times. In certain embodiments, cross-pairings of injection ports (34A-34D) and (34B-34C) may inject resin at alternating times. In certain embodiments, the injection ports 34A, 34B, 34C, and 34D are each individually turned on and off in sequential clockwise or counter clockwise order. While four such ports 34A-34D are shown it is appreciated that the number of injection ports ranges from 1 to 10 in various inventive embodiments, while in other embodiments, from 2 to 6 ports and in still other embodiments 2 or 3 ports are used.

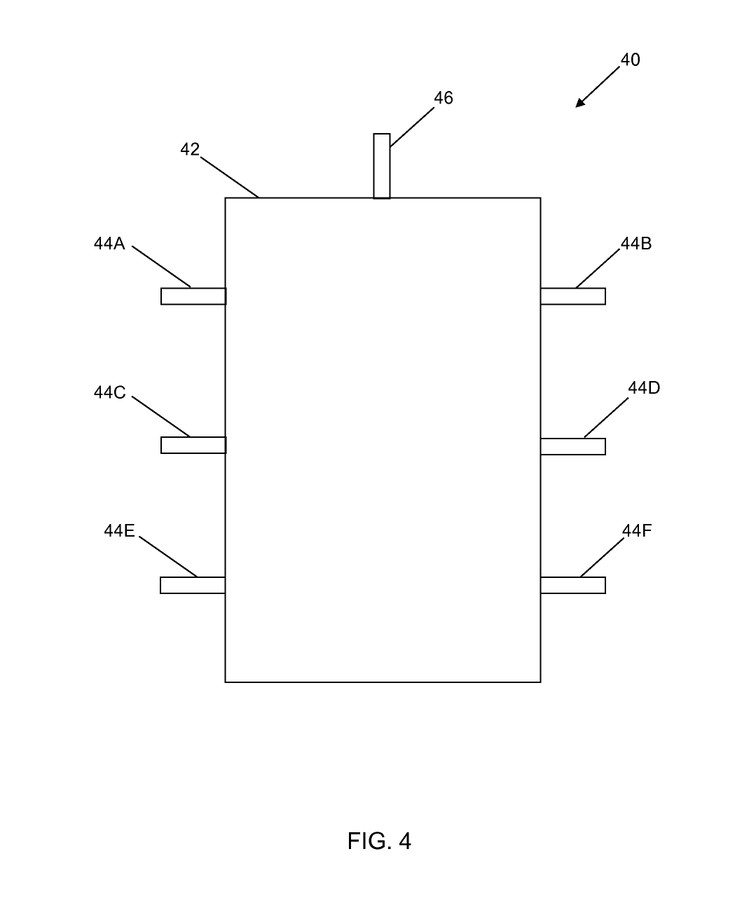

FIG. 4 is a plan view of a multiport RTM system 40 with a mold 42 with six injection ports 44A-44F for staggered resin injection and an exhaust port 46 according to embodiments of the invention. As was discussed with respect to the inventive embodiment of FIG. 3, the injection ports 44A-44F may be activated in any order both individually, and in groups, or pairings. As should be apparent the number possible combinations and configurations for activating and injecting resin through the various injection ports increases as the number of available injection ports increases for a given mold.

In embodiments of the inventive staggered RTM system and process; the firing or activation order and patterns of usage of the resin injectors are preprogrammed into a numerical controller or computing device with a processor and a storage medium for storing and executing the programs. In an embodiment of the inventive staggered RTM system, the numerical controller may also control a carousal with multiple injection mold fixtures that can be automatically loaded into position for the staggered multiport injection process, and then removed and another mold fixture can be moved into position while a formed part is removed from the first fixture.

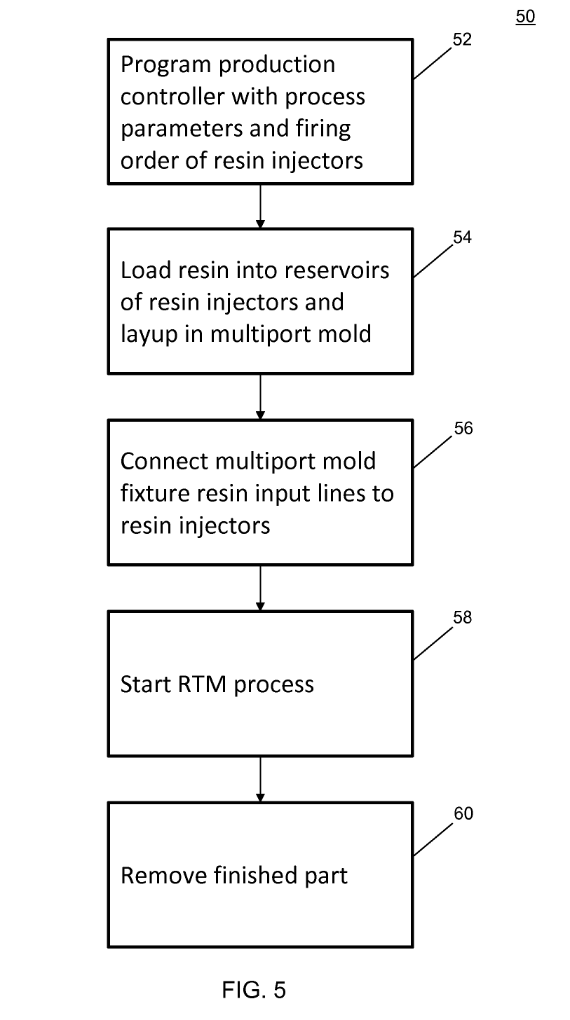

FIG. 5 is a flowchart of a production process 50 of the staggered multiport RTM process according to embodiments of the invention. The process starts with an operator programming a production controller (step 52) with process parameters for a particular molded part to be formed with the RTM process using a multi resin injection port mold. Process parameters including pressure, temperature, and firing sequence of the resin injectors are set by the operator based on the resin material and part to be formed in the RTM process. The operator loads the resin for forming the part into the reservoirs of the resin injectors, as well as the layup into the mold (step 54). The multiport mold fixture resin input lines are hooked up to the resin injectors (step 56). The RTM process is started (step 58), and the completed part is removed from the mold (step 60).

The foregoing description is illustrative of particular embodiments of the invention, but is not meant to be a limitation upon the practice thereof. The following claims, including all equivalents thereof, are intended to define the scope of the invention.

1. A process for resin transfer molding (RTM) with staggered injection of a resin, the process comprising:
injecting said resin into a plurality of injection ports of a mold;
controlling the temperature and pressure applied to said mold; and
wherein said plurality of injection ports are activated for injecting said resin in any order of individually, in groups, or pairings.

2. The process of claim 1 wherein said resin is at least one of an epoxy resin, an unsaturated polyester resin, a polyvinylester resin, a phenolic resin, a guanamine resin, a polyimide resin, a bismaleimide triazine resin, a furan resin, a polyurethane resin, a polydiarylphthalate resin, a melamine resin, a urea resin, or an amino resin.

3. The process of claim 1 wherein said resin further comprises fibers.

4. The process of claim 2 wherein said fibers are at least one of glass, carbon, or other synthetic fibers.

5. The process of claim 3 wherein said fibers are natural fibers.

6. The process of claim 5 wherein said natural fibers are at least one of coconut fibers, bamboo fibers, sugar cane fibers, or banana skin fibers.

7. The process of claim 1 wherein said plurality of injection ports are activated for injecting resin in a sequential clockwise or counter clockwise order.

8. The process of claim 1 wherein said plurality of injection ports are activated based on a computer program.

9. The process of claim 1 wherein said plurality of injection ports are from 2 to 6 injection ports.

10. The process of claim 1 wherein said plurality of injection ports are 3 injection ports.

11. The process of claim 1 further comprising repeating the steps of the injecting and the controlling with a cycle time of 1 to 5 minutes.

12. The process of claim 1 wherein the controlling limits a decline of pressure and temperature during formation of a molded part in said mold.

13. A resin transfer molding (RTM) system for performing the process of claim 1 comprising:
a mold having a cavity;
a plurality of injection ports each in fluid communication between the cavity and a reservoir of resin; and
a numerical controller for activating said plurality of injection ports for injecting resin from said reservoir into the cavity in any order of individually, in groups, or pairing.
